(19) United States
(12) Patent Application Publication
(10) Pub. No.: US 2025/0353127 A1
(43) Pub. Date: Nov. 20, 2025

(54) TOOL CHANGING ARM OF AUTOMATIC TOOL CHANGING DEVICE

(71) Applicant: SANJET INTERNATIONAL CO., LTD., Taichung City (TW)

(72) Inventor: Ching-San CHANG, Taichung City (TW)

(73) Assignee: SANJET INTERNATIONAL CO., LTD., Taichung City (TW)

(21) Appl. No.: 18/665,904

(22) Filed: May 16, 2024

(51) Int. Cl. B23Q 3/155

(52) U.S. Cl. CPC B23Q 3/1554; B23Q 2003/155414

(57) ABSTRACT

A tool changing arm of an automatic tool changing device includes an elongated body, wherein two ends of the elongated body respectively form two holding arms, and each holding arm could hold a tool holder with a tool fastening unit. Each tool fastening unit includes a positioning seat, a tool fastening rod, and a pushing member, wherein the positioning seat disposed in a groove of the elongated body has a through hole and a stop surface. The tool fastening rod is disposed in the groove, and a part of the tool fastening rod passes through the through hole. The tool fastening rod keeps moving towards the tool holder due to an action of the pushing member, wherein the tool fastening rod has a positioning surface capable of contacting the stop surface, thereby preventing improper loosening of the tool fastening rod.

### BACKGROUND OF THE INVENTION

### Technical Field

The present invention relates generally to automatic tool changing devices, and more particularly to a tool changing arm adapted to hold a tool holder for changing tools.

### Description of Related Art

A conventional tool changing arm of an automatic tool changing device of a machine tool includes an elongated body, wherein two opposite ends of the elongated body respectively constitute two holding portions. Each of the holding portions consists essentially of a holding arm and a tool fastening rod. Each of the holding arms having a side opening is connected to the elongated body. Each of the tool fastening rods could be insert parallel into an axial hole of the elongated body, and an end of each of the tool fastening rods extends to each of the side openings. When each of the tool fastening rods keeps moving towards each of the side openings due to a spring force of a spring and awaits a tool holder to enter each of the side openings, the end of each of the tool fastening rods extending to each of the side openings could abut against the tool holder, thereby ensuring that the tool holder is stably held.

To prevent the tool fastening rod from improperly loosening from the elongated body when the tool holder is not being held, an elongated recess or an elongated through hole is normally disposed on the tool fastening rod along an axial direction, and a positioning pin is fixed on the elongated body. An end of the positioning pin could restrict a movement boundary of the tool fastening rod by extending into the elongated recess or passing through the elongated through hole. While the positioning pin could prevent improper loosening of the tool fastening rod caused by the spring pushing the tool fastening rod outward, drilling a hole in a predetermined position on the elongated body is necessary to accommodate the positioning pin. At the same time, the elongated groove or the through hole is necessarily made on the tool fastening rod, thereby weakening the structural strength of both the elongated body and the tool fastening rod itself. Additionally, in the existing tool changing arm, dust and foreign body often get stuck between a hole wall of the axial hole of the elongated body and a surface of the tool fastening rod, as a result the tool fastening rod could not move smoothly. In severe cases, this could adversely affect the effectiveness of the tool fastening rod in abutting against the tool holder.

### BRIEF SUMMARY OF THE INVENTION

In view of the above, the primary objective of the present invention is to provide a tool changing arm of an automatic tool changing device, wherein the tool changing arm ensures the smooth movement of a tool fastening rod and the structural strengths of both an elongated body and the tool fastening rod itself would not be weakened.

The present invention provides a tool changing arm of an automatic tool changing device includes an elongated body and at least one tool fastening unit, wherein the elongated body could rotate about an axis, and two ends of the elongated body respectively form two holding arms. Each of the holding arms has a side opening, wherein at least one of the holding arms could hold a tool holder with the at least one tool fastening unit. Additionally, the elongated body further includes at least one receiving hole and at least one groove, wherein an end of the at least one groove communicates with the at least one receiving hole, and another end of the at least one groove communicates with at least one of the side openings. The at least one tool fastening unit includes a brake pin, a positioning seat, a tool fastening rod, and a pushing member, wherein the brake pin is disposed in the at least one receiving hole and could move between a first position and a second position along a first direction. The positioning seat disposed in the at least one groove has a stop surface and a through hole, wherein the through hole communicates with both the at least one groove and the at least one of the side openings. The tool fastening rod is disposed in the at least one groove, and a part of the tool fastening rod passes through the through hole of the positioning seat. The tool fastening rod could move between a third position and a fourth position along a second direction, wherein a position where the tool fastening rod is in contact with the stop surface of the positioning seat is defined as the third position. The pushing member is adapted to push the tool fastening rod to keep moving toward the third position. The first direction and the second direction are non-parallel directions. When the brake pin is located at the first position, the tool fastening rod is located at the third position or close to the third position, and when the brake pin is located at the second position, the tool fastening rod could move towards the fourth position.

With the coordination of the groove and the positioning seat, the tool fastening rod could move stably in parallel, and the positioning seat could also restrict a movement boundary of the tool fastening rod. This eliminates the need for any additional recesses or holes to be made on the elongated body or tool fastening rod.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the tool changing arm of the automatic tool changing device according to an embodiment of the present invention;

FIG. 2 is an exploded view of a part of the tool changing arm in FIG. 1;

FIG. 3 is a partially top view of the elongated body of the tool changing arm in FIG. 2;

FIG. 4 is an exploded view of the tool fastening unit of the tool changing arm in FIG. 2;

FIG. 5 is a partially top view of the tool changing arm in FIG. 1;

FIG. 6 is a sectional view along the 6-6 line in FIG. 5;

FIG. 7 is similar to FIG. 5, showing the omission of the upper cover and cover in the tool changing arm;

FIG. 8 is a partially perspective view of the embodiment of the present invention;

FIG. 9 is similar to FIG. 6, showing the tool changing arm in the state of holding the tool holder;

FIG. 10 is similar to FIG. 7, showing the tool changing arm in the state of holding the tool holder;

FIG. 11 is similar to FIG. 10, showing the tool changing arm in the state of completely holding the tool holder.

### DETAILED DESCRIPTION OF THE INVENTION

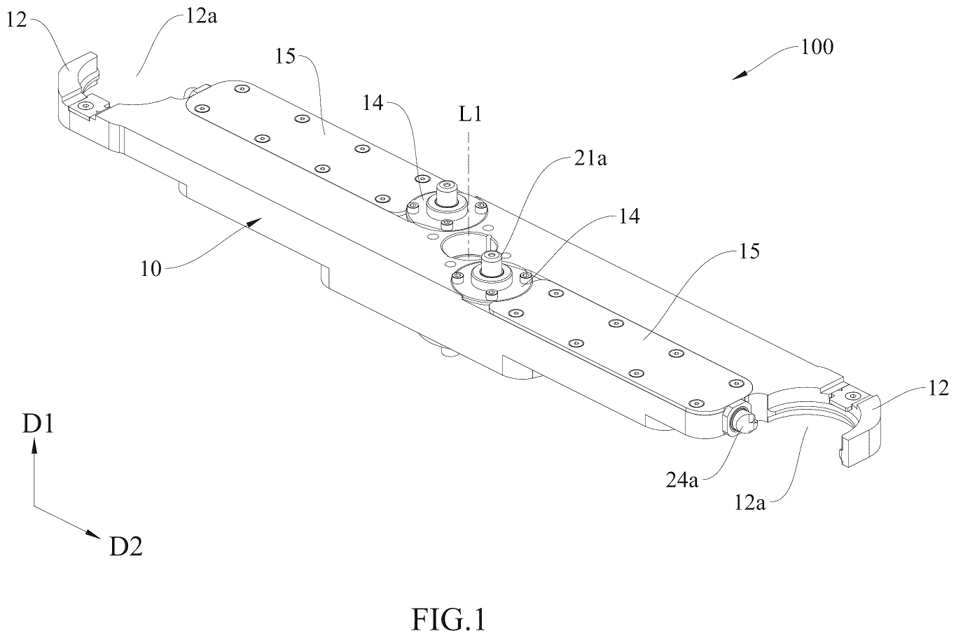

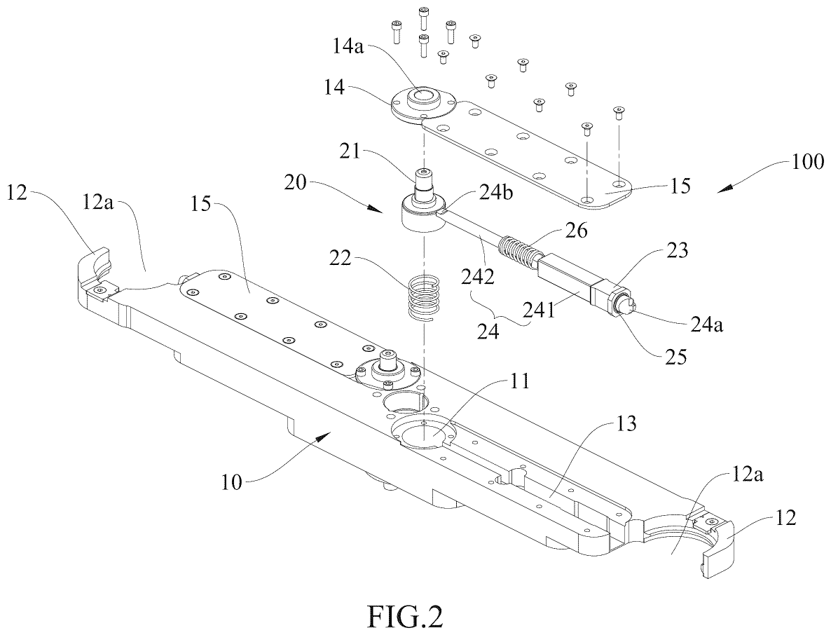

A tool changing arm 100 of an automatic tool changing device according to an embodiment of the present invention is illustrated in FIG. 1 and FIG. 2 and is connected to an end of a transmission shaft of a tool changing device (not shown), wherein the transmission shaft drives the tool changing arm 100 to rotate. The tool changing arm 100 includes an elongated body 10 and at least one tool fastening unit 20. The elongated body 10 could rotate about an axis L1 passing through a center of the transmission shaft. The elongated body 10 is provided with a receiving hole 11 on each of two sides of the axis L1, wherein a bottom of each of the receiving holes 11 is not penetrated. A holding arm 12 is formed at each of two ends of the elongated body 10, wherein each of the holding arms 12 has a side opening 12a. The elongated body 10 has two grooves 13 formed by recessing into a top surface of the elongated body 10, wherein each of the grooves 13 communicates with both one of the receiving holes 11 and the side opening 12a of one of the holding arms 12. Additionally, the elongated body 10 is combined with an upper cover 14 in a circular shape at each corresponding receiving hole 11 and a cover 15 in a rectangular shape at each corresponding groove 13, wherein the upper covers 14 are adapted to seal the respective receiving holes 11, and the covers 15 are adapted to seal the respective grooves 13.

In the current embodiment, the number of the receiving holes 11 is two, and the number of the grooves 13 is two. In other embodiments, the number of the receiving hole 11 and the groove 13 might also be one, wherein the receiving hole 11 is combined with one upper cover 14 and the groove 13 is combined with one cover 15.

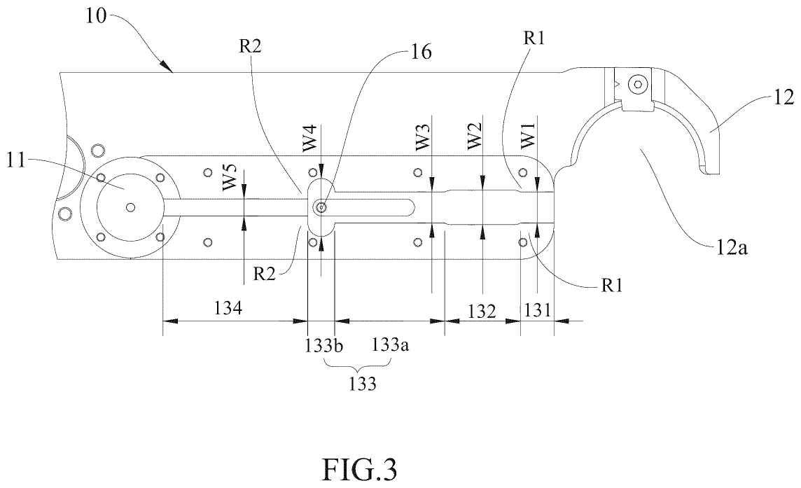

Each of the grooves 13 of the elongated body 10 is a groove with two groove walls and a groove bottom, wherein at least one of the two groove walls has an abutting shoulder portion R1 protruding towards the opposite groove wall. As shown in FIG. 3, each of the grooves 13 according to the embodiment sequentially includes a first groove section 131, a second groove section 132, a third groove section 133, and a fourth groove section 134, wherein the first groove section 131 is communicated with the corresponding side opening 12a, and the fourth groove section 134 is communicated with the corresponding receiving hole 11. As shown in FIG. 3, each of the first groove sections 131 has a first groove width W1, and each of the second groove sections 132 has a second groove width W2. Each of the third groove sections 133 includes a narrow section 133a and a wide section 133b corresponding to two different groove widths within the third groove section 133. The narrow section 133a has a third groove width W3, and the wide section 133b has a fourth groove width W4, wherein the third groove width W3 is less than the fourth groove width W4. Each of the fourth groove sections 134 has a fifth groove width W5. Furthermore, each of the first groove widths W1 is less than each of the second groove widths W2, so that each of the two groove walls of each of the grooves 13 forms the abutting shoulder portion R1 protruding towards the opposite groove wall at a junction of the first groove section 131 and the second groove section 132. From the aforementioned it can be seen that, in the current embodiment, the number of the abutting shoulder portions R1 of each of the grooves 13 is two; the narrow section 133a of each of the third groove sections 133 is connected to each of the second groove sections 132, and each of the third groove widths W3 is less than each of the second groove widths W2; the wide section 133b of each of the third groove sections 133 is connected to each of the fourth groove sections 134, and each of the fourth groove widths W4 is greater than each of the fifth groove widths W5, so that each of the grooves 13 forms a stop portion R2 at a junction of the wide section 133b of the third groove section 133 and the fourth groove section 134. Additionally, the elongated body 10 is further provided with an injection hole 16 at a position of the third groove section 133 of each of the grooves 13, wherein the injection holes 16 are adapted to respectively inject lubricating oil into the grooves 13.

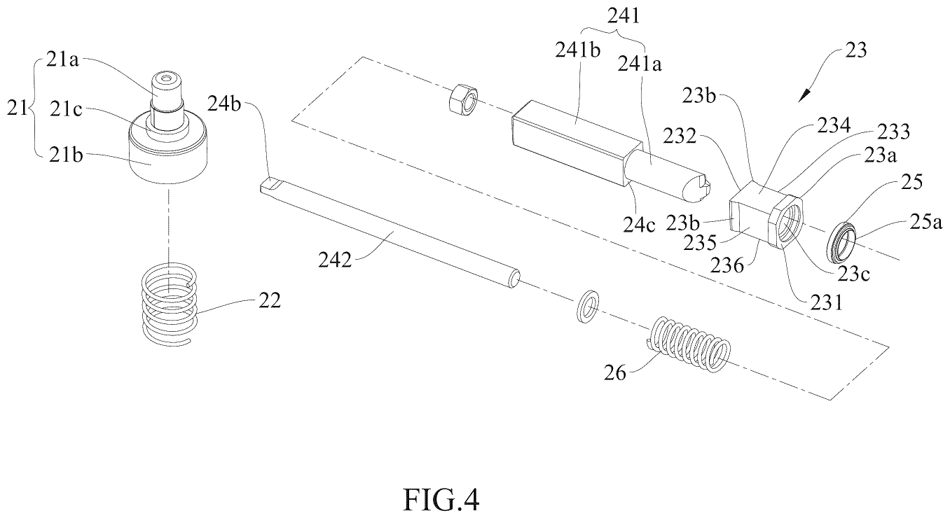

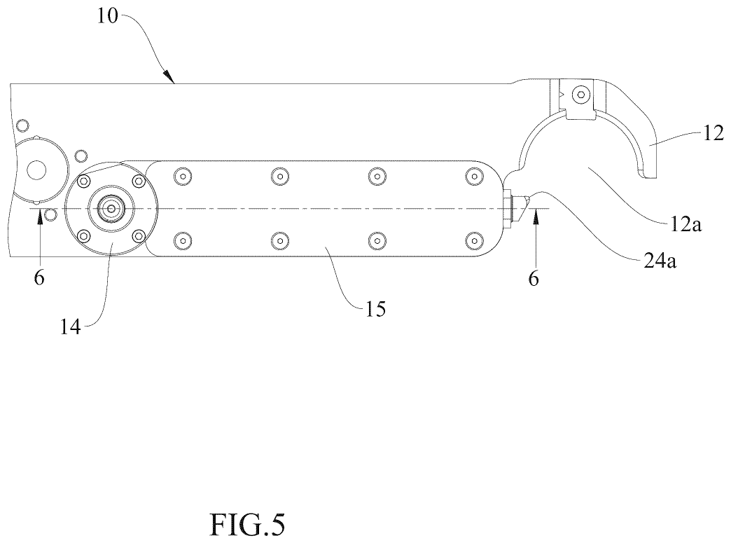

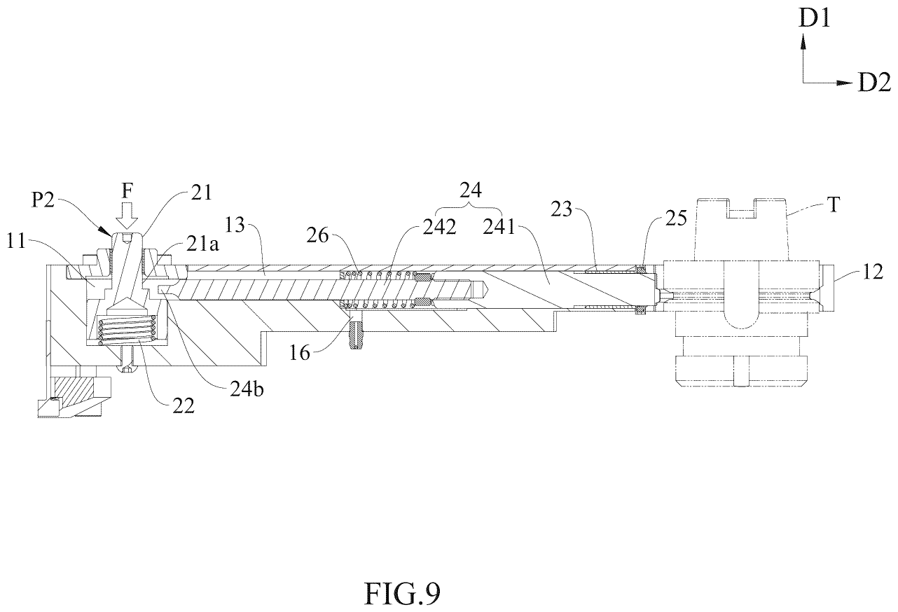

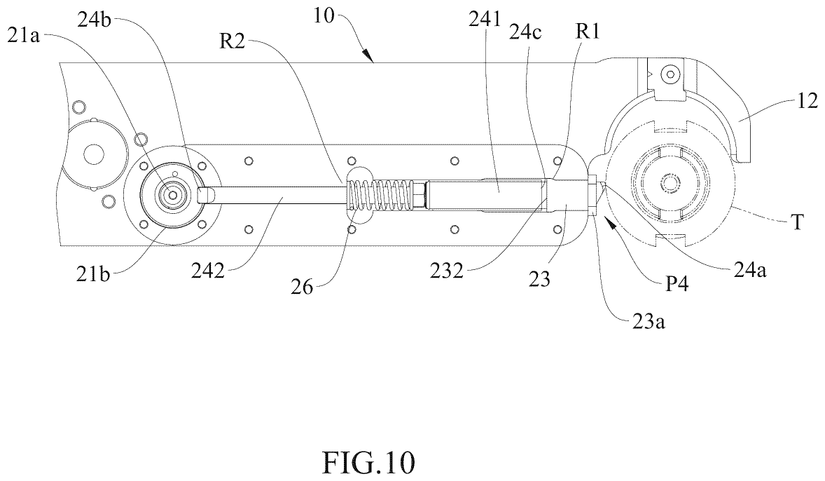

The at least one tool fastening unit 20 could hold a tool holder T with at least one of the holding arms 12 (as shown in FIG. 9 and FIG. 10). In the current embodiment, two tool fastening units 20 are provided, each of the tool fastening units 20, together with the respective holding arm 12 of each end of the elongated body 10, forms a structure capable of holding the tool holder T. As the structures of the two tool fastening units 20 are identical, one of the tool fastening units 20 and the corresponding holding arm 12 are used for illustration. As shown in FIG. 4 to FIG. 7, the tool fastening unit 20 according to the embodiment includes a brake pin 21, a spring 22, a positioning seat 23, a tool fastening rod 24, a dust collar 25, and a pushing member which is exemplified by a spring 26 but not limited thereto. The detailed descriptions are provided below regarding the structural features and respective positions of the aforementioned elements.

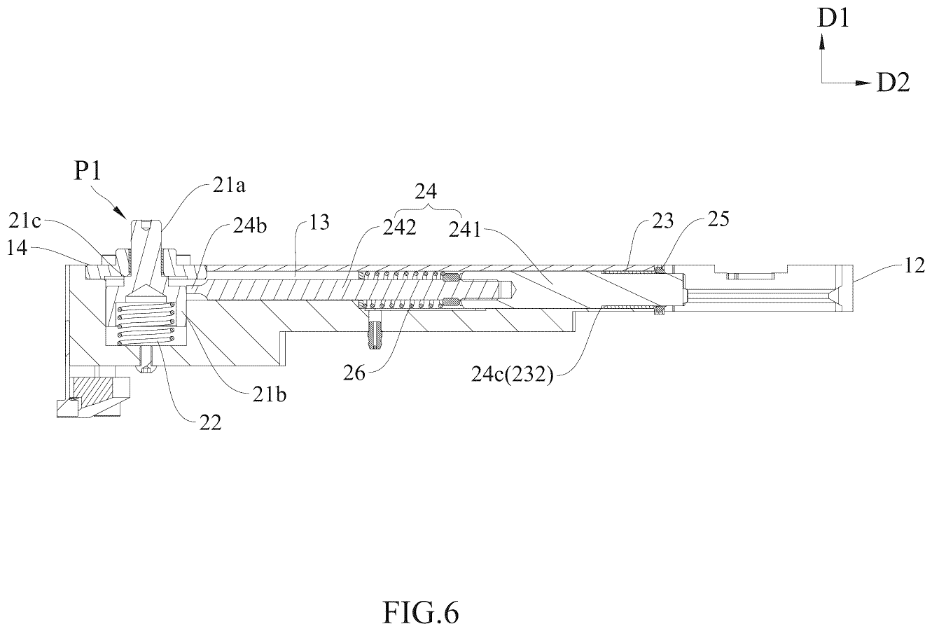

The brake pin 12 and the spring 22 are together disposed in the receiving hole 11. The brake pin 12 has a minor diameter section 21a, a major diameter section 21b, and a shoulder portion 21c, wherein the minor diameter section 21a could pass through a through hole 14a of the upper cover 14 and extend outward of the through hole 14a, and the shoulder portion 21c is located at a junction of the minor diameter section 21a and the major diameter section 21b. An end of the spring 22 abuts against the bottom of the receiving hole 11, while another end of the spring 22 abuts against the major diameter section 21b. The brake pin 21 keeps moving towards a first direction D1 due to a spring force of the spring 22. The brake pin 21 is fixed in a position when the shoulder portion 21c of the brake pin 21 abuts against a bottom surface of the upper cover 14, wherein the position where the brake pin 21 is fixed is defined as a first position P1, and a portion of the major diameter section 21b of the brake pin 21 aligns with the groove 13 (as shown in FIG. 6).

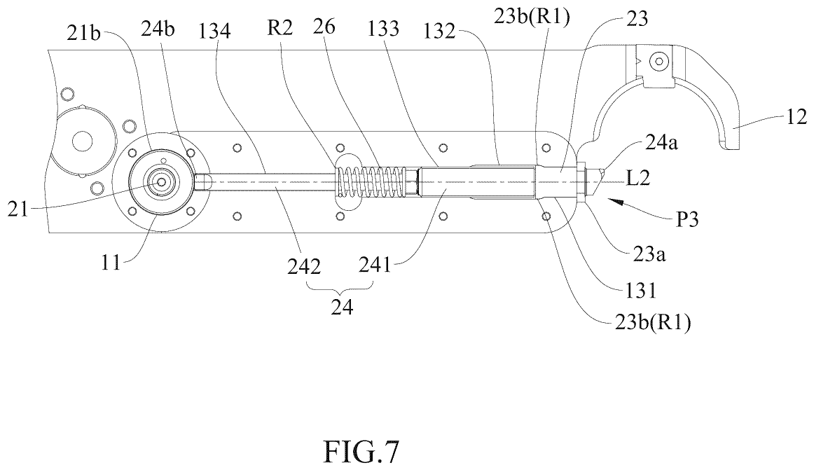

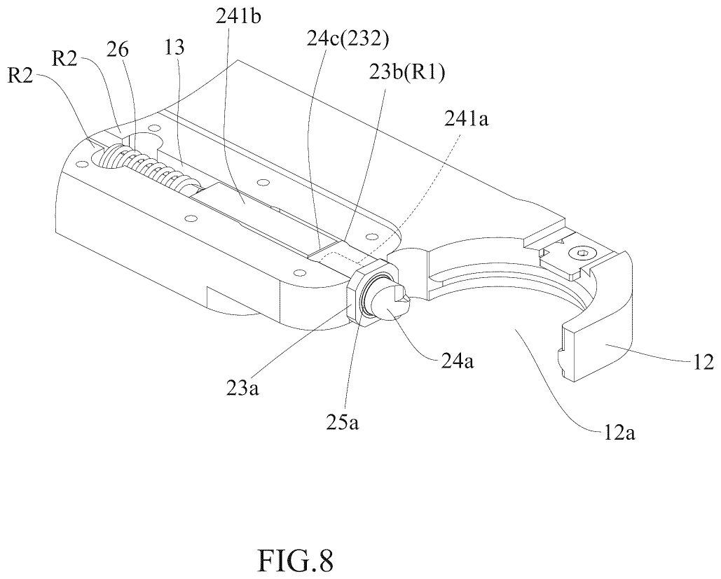

As shown in FIG. 4, FIG. 7, and FIG. 8, the positioning seat 23 is disposed in the first groove section 131 of the groove 13. To coordinate with the shape of the groove 13, the positioning seat 23 according to the embodiment is a rectangular block with a front end surface 231, a rear end surface 232, and four side surfaces 233, 234, 235, and 236. The positioning seat 23 is divided into a front section and a rear section, wherein the front section forms a ring block 23a protruded outward along the side surfaces 233, 234, 235, and 236, and the ring block 23a is defined as a front abutting portion according to the present invention; the rear section has two stop blocks 23b formed by the side surfaces 233, and 235, which protrude outward and face the groove walls of groove 13. Furthermore, the two stop blocks 23b are respectively protruded from the side surfaces 233 and 235, forming an integral part and is defined as a rear abutting portion according to the present invention. Additionally, the positioning seat 23 further includes a through hole 23c penetrating both the front end surface 231 and the rear end surface 232, wherein the rear end surface 232 is defined as a stop surface according to the present invention. As shown in FIG. 7 and FIG. 8, after assembly, the ring block 23a of the positioning seat 23 is located outside the groove 13 and abuts against a surface of the elongated body 10. The two stop blocks 23b extend to the second groove section 132 and respectively abut against the abutting shoulder portions R1, so that the positioning seat 23 is stably located within the first groove section 131 and would not move randomly along a second direction D2 orthogonal to the first direction D1. Meanwhile, the through hole 23c is communicated with both the groove 13 and the side opening 12a. Additionally, the positioning seat 23 is prevented from loosening from the groove 13 due to the constraint provided by the cover 15. Specifically, the side surface 234 of the positioning seat 23 faces the cover 15, and the side surface 236 of the positioning seat 23 faces the groove bottom of the groove 13.

In the current embodiment, the number of the stop block 23b is two, and the two blocks 23b constitute the rear abutting portion. In other embodiments, the number of the stop block 23b might also be one, wherein the stop block 23b is protruded from either the side surface 233 or the side 235, forming an integral part and constituting the rear abutting portion.

The tool fastening rod 24 is disposed in the groove 13 in a way that the tool fastening rod 24 could move along the second direction D2, and a part of the tool fastening rod 24 passes through the through hole 23c, wherein the tool fastening rod 24 is prevented from loosening from the groove 13 due to the constraint provided by the cover 15. Two ends of the tool fastening rod 24 are respectively named a front abutting end 24a and a rear abutting end 24b, wherein the front abutting end 24a is adapted to abut against the tool holder T, and the rear abutting end 24b is adapted to contact with the brake pin 21. In the current embodiment, the tool fastening rod 24 includes a first body 241 and a second body 242 which are both located on an extension line L2. The second body 242 is connected to the first body 241. Preferably, the second body 242 is connected to the first body 241 in a way that a connection length between the front abutting end 24a and the rear abutting end 24b is adjustable, thereby enhancing the practicality of the tool fastening rod 24. One way to achieve the aforementioned adjustment of the connection length is exemplified by providing a threaded hole in the first body 241 and a threaded section in the second body 242 but not limited thereto, achieving the aforementioned purpose by the screwing way.

The first body 241 according to the embodiment is illustrated in FIG. 7 and FIG. 8 and has a cylindrical section 241a and a rectangular section 241b. The first body 241 passes through the through hole 23c by the cylindrical section 241a of the first body 241, and an end of the cylindrical section 241a extended to the side opening 12a constitutes the front abutting end 24a. The rectangular section 241b is connected to the cylindrical section 241a, and a junction of the rectangular section 241b and the cylindrical section 241a constitutes the positioning surface 24c (as shown in FIG. 4); an end of the second body 242 is connected to the rectangular section 241b, and another end of the second body 242 constitutes the rear abutting end 24b. The rear abutting end 24b aligns with the major diameter section 21b of the brake pin 21 located at the first position P1. When the tool fastening rod 24 is disposed in the groove 13, the first body 24 crosses the first groove section 131, the second groove section 132, and a part of the third groove section 133, and the second body 242 crosses the other part of the third groove section 133, and the fourth groove section 134.

The dust collar 25 is combined with the through hole 23c of the positioning seat 23 and is positioned near the ring block 23a. The dust collar 25 has a lip edge 25a. When the cylindrical section 241a of the first body 241 of the tool fastening rod 24 passes through the dust collar 25, the lip edge 25a snugly fits around a peripheral surface of the cylindrical section 241a. In other embodiments, the dust collar 25 is made of rubber and has a deformable capability to ensure smooth movement of the tool fastening rod 24, and also preventing foreign body from entering the groove 13 through the through hole 23c of the positioning seat 23.

The spring 26 fits around the second body 242 and is located in the third groove section 133, wherein an end of the spring 26 acts at the stop portion R2 of the elongated body 10, and another end of the spring 26 acts at the first body 241 of the tool fastening rod 24. The tool fastening rod 24 keeps moving towards the side opening 12a due to a spring force of the spring 26. The positioning surface 24c of the tool fastening rod 24 is in contact with the rear end surface 232 of the positioning seat 23, wherein the position where the tool fastening rod 24 is located is defined as a third position P3. In other words, the spring 26 pushes the tool fastening rod 24 to keep moving towards the third position P3.

The aforementioned statement describes each of the structures in a state where the two ends of the tool changing arm 100 according to an embodiment of the present invention have not held the tool holder T. The brake pin 21 in the state is located at the first position P1, and the positioning surface 24c of the tool fastening rod 24 is in contact with the rear end surface 232 of the positioning seat 23 and is stopped at the third position P3 due to the spring force of the spring 26. Meanwhile, there is a slight gap of about 1 mm in practice between the rear abutting end 24b of the tool fastening rod 24 and a peripheral surface of the major diameter section 21b of the brake pin 21. The purpose of reserving the slight gap is to ensure smooth action when holding the tool holder T.

The tool changing arm 100 is illustrated in FIG. 9 and FIG. 10 and changes tools based on the rotation of the transmission shaft of the tool changing device. At this time, the brake pin 21 of the tool fastening unit 20 moves back to a second position P2 within the receiving hole 11 and compresses the spring 22 due to a lateral force F. The part of the brake pin 21 aligning with the groove 13 changes to the minor diameter section 21a of the brake pin 21 when the brake pin 21 is located at the second position P2, so that a distance between the minor diameter section 21a and an end opening communicating with both the groove 13 and the receiving hole 11 increases, allowing the tool fastening rod 24 to move parallel along the second direction D2. In the process of the elongated body 10 holding the tool holder T by the holding arm 12 of the elongated body 10, the tool holder T pushes against the front abutting end 24a of the tool fastening rod 24, so that the tool fastening rod 24 moves toward the brake pin 21 and simultaneously compresses the spring 26. The position of the tool fastening rod 24 is defined as a fourth position P4 when the tool holder T could smoothly pass through the front abutting end 24a (as shown in FIG. 10).

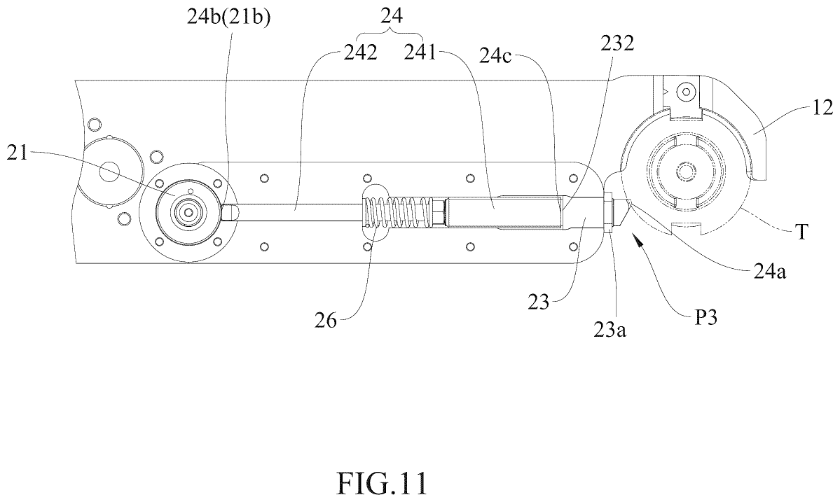

When the tool holder T enters the side opening 12a and abuts against an inner edge of the holding arm 12, the spring 26 releases a compressed energy to keep pushing the brake pin 21 towards the third position P3 (as shown in FIG. 11) and causes the front abutting end 24a to abut against the tool holder T, preventing the tool holder T from loosening. Meanwhile, the spring 22 keeps pushing the brake pin 21 from the second position P2 back to the first position P1 (as shown in FIG. 6). In this state, the major diameter section 21b of the brake pin 21 once again abuts against the rear abutting end 24b of the tool fastening rod 24, so that the tool fastening rod 24 could not move randomly in parallel and the tool holder T remains stably held. It is worth noting that, in the aforementioned state of the tool holder T, the brake pin 21 has returned to the second position P2, and the tool holder T pushes against the tool fastening rod 24, so that the rear abutting end 24b of the tool fastening rod 24 abuts against the major diameter section 21b. This indirectly leads to a gap of about 1 mm between the positioning surface 24c of the tool fastening rod 24 and the rear end surface 232 of the positioning seat 23, and the purpose of reserving the gap is also to ensure smooth action when holding the tool holder T. The position of the tool fastening rod 24 in this state is defined as being close to the third position P3.

From the aforementioned, it can be seen that in the current embodiment, the tool changing arm 100 imposes a restriction on the movement of the tool fastening rod 24 towards the side opening 12a by the rear end surface 232 of the positioning seat 23, so that the tool changing arm 100 prevents the tool fastening rod 24 from improper loosening. In other words, the tool changing arm 100 according to the embodiment could maintain the structural strength without either providing a positioning pin or drilling a hole on the elongated body 10, not to mentioned an elongated recess or an elongated through hole made on the tool fastening rod 24. Secondly, the design of the dust collar 25 could effectively prevent dust and foreign body from entering the groove 13 through the through hole 23c of the positioning seat 23 to ensure the smooth movement of the tool fastening rod 24.

Additionally, it is worth noting that the design of the positioning seat 23 abutting against the two abutting shoulder portion R1 by the two blocks 23b of the positioning seat 23 ensures that lubricating oil injected from the injection hole 16 into the groove 13 is blocked by the rear end surface 232 of the positioning seat 23, so that the design prevents lubricating oil from permeating to the outside. The design guarantees effective lubrication for the movement of the tool fastening rod 24 without the need for frequent inspection of grease levels or frequent replenishment.

It must be pointed out that the embodiments described above are only some preferred embodiments of the present invention. All equivalent structures which employ the concepts disclosed in this specification and the appended claims should fall within the scope of the present invention.

What is claimed is:

1. A tool changing arm of an automatic tool changing device, comprising an elongated body and at least one tool fastening unit, wherein the elongated body can rotate about an axis, and two ends of the elongated body respectively form two holding arms; each of the holding arms has a side opening, wherein at least one of the holding arms can hold a tool holder with the at least one tool fastening unit; the tool changing arm is characterized in that:
the elongated body has at least one receiving hole and at least one groove, wherein an end of the at least one groove communicates with the at least one receiving hole, and another end of the at least one groove communicates with at least one of the side openings;
the at least one tool fastening unit comprises a brake pin, a positioning seat, a tool fastening rod, and a pushing member, wherein the brake pin is disposed in the at least one receiving hole and can move between a first position and a second position along a first direction; the positioning seat disposed in the at least one groove has a stop surface and a through hole, wherein the through hole communicates with both the at least one groove and the at least one of the side openings; the tool fastening rod is disposed in the at least one groove, and a part of the tool fastening rod passes through the through hole of the positioning seat; the tool fastening rod can move between a third position and a fourth position along a second direction, wherein a position where the tool fastening rod is in contact with the stop surface of the positioning seat is defined as the third position; the pushing member is adapted to push the tool fastening rod to keep moving toward the third position; wherein the first direction and the second direction are non-parallel directions; when the brake pin is located at the first position, the tool fastening rod is located at the third position or close to the third position, and when the brake pin is located at the second position, the tool fastening rod can move towards the fourth position.

2. The tool changing arm of the automatic tool changing device as claimed in claim 1, wherein the at least one groove of the elongated body has two groove walls and a groove bottom; at least one of the groove walls has an abutting shoulder portion protruding towards the opposite groove wall; the positioning seat has a front abutting portion and a rear abutting portion opposite to each other, wherein the front abutting portion is located outside the at least one groove and abuts against a surface of the elongated body, and the rear abutting portion extends to the second groove section and abuts against the abutting shoulder portion; wherein at least one cover is combined with the elongated body and restrains both the positioning seat and the tool fastening rod within the at least one groove.

3. The tool changing arm of the automatic tool changing device as claimed in claim 2, wherein the positioning seat is a rectangular block with a front end surface, a rear end surface, and four side surfaces; the through hole penetrates both the front end surface and the rear end surface, wherein the rear end surface constitutes the stop surface; two opposite side surfaces of the positioning seat respectively face the two groove walls of the at least one groove, and the other two opposite side surfaces respectively face the groove bottom of the at least one groove and the at least one cover; a front section of the positioning seat has a ring block constituting the front abutting portion, wherein the ring block is formed by protruding outward along the side surfaces; a rear section of the positioning seat has at least one stop block constituting the rear abutting portion, wherein the at least one stop block is formed by at least one side surface of two side surfaces facing the two groove walls protruding outward.

4. The tool changing arm of the automatic tool changing device as claimed in claim 1, wherein the tool fastening rod has a first body and a second body both located on an extension line; the first body passes through the through hole, and an end of the first body extends to the at least one of the side openings; the second body is connected to the first body in a way that a connection length is adjustable, wherein the first body has a positioning surface capable of contacting the stop surface, so that the tool fastening rod is located at the third position.

5. The tool changing arm of the automatic tool changing device as claimed in claim 4, wherein the first body has a cylindrical section and a rectangular section; the cylindrical section passes through the through hole, and an end of the cylindrical section extending to the at least one of the side openings constitutes a front abutting end; the rectangular section is connected to the cylindrical section, and a junction of the rectangular section and the cylindrical section constitutes the positioning surface; the second body has a rear abutting end, wherein in a state where the tool holder is being hold and the front abutting end abuts against the tool holder, the rear abutting end is in contact with the brake pin.

6. The tool changing arm of the automatic tool changing device as claimed in claim 4, wherein the at least one groove of the elongated body sequentially comprises a first groove section, a second groove section, a third groove section, and a fourth groove section; the first groove section is communicated with the at least one of the side openings, and the fourth groove section is communicated with the at least one receiving hole; wherein the positioning seat is disposed in the first groove section; the first body of the tool fastening rod is disposed in the first groove section, the second groove section, and a part of the third groove section; the second body is disposed in the other part of the third groove section and the fourth groove section; the pushing member comprises a spring which fits around the second body and is disposed in the third groove section, wherein an end of the spring acts at the elongated body, and another end of the spring acts at the tool fastening rod.

7. The tool changing arm of the automatic tool changing device as claimed in claim 6, wherein the elongated body has an injection hole communicating with the third groove section, and the injection hole is adapted to inject lubricating oil into the at least one groove.

8. The tool changing arm of the automatic tool changing device as claimed in claim 7, wherein a width of the first groove section is less than a width of the second groove section, so that a junction of the first groove section and the second groove section forms at least one abutting shoulder portion; a width of the third groove section is greater than a width of the fourth groove section, so that a junction of the third groove section and the fourth groove section forms at least one stop portion; wherein the positioning seat has a front abutting portion and a rear abutting portion opposite to each other; the front abutting portion extends outward of the first groove section and abuts against a surface of the elongated body; the rear abutting portion extends in the second groove section and abuts against the at least one abutting shoulder portion; an end of the spring acts at the at least one stop portion, and another end of the spring acts at the first body.

9. The tool changing arm of the automatic tool changing device as claimed in claim 1, wherein the at least one tool fastening unit comprises a dust collar combined with the through hole of the positioning seat, and the tool fastening rod passes through the dust collar.
